(19) United States
(12) Patent Application Publication
(10) Pub. No.: US 2017/0149317 A1
(43) Pub. Date: May 25, 2017

(54) Rotor For A Permanent-Magnet Synchronous Motor

(71) Applicant: Continental Automotive GmbH, Hannover (DE)

(72) Inventor: Thomas Mann, Nidderau (DE)

(73) Assignee: Continental Automotive GmbH, Hannover (DE)

(21) Appl. No.: 15/115,946

(22) PCT Filed: Jul. 1, 2015
(86) PCT No.: PCT/EP2015/064934

§ 371 Date: Aug. 2, 2016

(30) Foreign Application Priority Data
Jul. 2, 2014 (DE) 10 2014 212 807.2

(51) Int. Cl. H02K 15/03; B21D 22/02; H02K 1/27

(52) U.S. Cl. CPC H02K 15/03; H02K 1/274; B21D 22/02

(57) ABSTRACT

The present disclosure relates to motors in general and, specifically relates to methods for producing a rotor for a permanently excited synchronous motor. A method may include: arranging a plurality of permanent magnets in a spoke-shaped pattern; and disposing a number of sheet metal elements between the respective permanent magnets. The respective sheet metal elements may be arranged one above the other and connected to one another. The respective sheet metal elements may include sections of soft-iron cores, a ring in the center of the rotor, and thin connecting pieces that connect the soft-iron core sections to the ring. A packet of sheet metal elements may be produced by: stamping out a first sheet metal element comprising at least one connecting piece and a maximal number of connecting pieces that corresponds to one less than the number of the soft-iron core sections; and stamping out further sheet metal elements with an identical stamped-out geometry as the first sheet metal element, rotating the stamping device between elements by an angle that corresponds to 360° divided by the number of the soft-iron cores.

### CROSS-REFERENCE TO RELATED APPLICATIONS

This application is a U.S. National Stage Application of International Application No. PCT/EP2015/064934 filed Jul. 1, 2015, which designates the United States of America, and claims priority to DE Application No. 10 2014 212 807.2 filed Jul. 2, 2014, the contents of which are hereby incorporated by reference in their entirety.

### TECHNICAL FIELD

The present disclosure relates to motors in general and, specifically describes methods for producing a rotor for a permanently excited synchronous motor.

### BACKGROUND

Some permanently excited synchronous motors comprise a plurality of permanent magnets that are arranged in a spoke-shaped pattern and a packet of a plurality of sheet metal elements provided between said permanent magnets. The sheet metal elements are arranged one above the other and connected to one another and comprise sections of soft-iron cores, a ring in the center of the rotor, and thin connecting pieces that connect the soft-iron core sections to the ring.

The percentage cost of the material in the case of such rotors, in particular for the use in compact high performance-BLDC-motors (brushless direct current motors) is very high. This is because of the required number of permanent magnets that are produced in particular from rare earths. Endeavors are therefore currently being made in the case of motors of this type to reduce the proportion of magnet material as far as possible without reducing the performance of the motor. One possibility for this resides in embedding the magnets in the soft-iron material. The magnets are arranged especially in this case in a spoke-shaped pattern as is usual in the case of the “collector-type construction”. Soft-iron cores that guide the magnetic flux are arranged between the individual magnets.

The soft-iron cores are produced from individual sheet metal elements that are arranged one above the other and are grouped together to form a sheet metal packet. In order to make the handling and stabilization of a single-part sheet metal packet of this type easier, it is necessary to connect the individual thin sheet metal elements by way of thin connecting pieces to a circumferential ring in the center of the rotor. In order to maintain the magnetic flux losses as low as possible, the number and the cross-section of the connecting pieces and also of the ring cross-section are to be kept as small or as narrow as possible.

The soft-iron region of a rotor of this type is therefore formed from a packet of a plurality of sheet metal elements that are arranged one above the other and are connected to one another. Each sheet metal element comprises in the case of the prior art a soft-iron core section, a ring in the center of the rotor and a thin connecting piece that connects the soft-iron core section to the ring.

It is moreover known to solve the problem of reducing the cross-section of the connecting piece by providing the individual sheet metal laminas (sheet metal elements) with different stamped-out sections that can then be used in an alternating manner. In the case of this embodiment, connecting pieces are therefore provided that always recur in defined spacings.

### SUMMARY

Teachings of the present disclosure may be employed to practice an example method for producing a rotor for a permanently excited synchronous motor that comprises a plurality of permanent magnets that are arranged in a spoke-shaped pattern and a packet of a plurality of sheet metal elements provided between said permanent magnets, said sheet metal elements being arranged one above the other and connected to one another and said sheet metal elements comprising sections of soft-iron cores, a ring in the center of the rotor and thin connecting pieces that connect the soft-iron core sections to the ring. The method may include:
producing the sheet metal element packet by means of:
stamping out a first sheet metal element in such a manner that the sheet metal element comprises at least one connecting piece and a maximal number of connecting pieces that corresponds to the number of the soft-iron core sections −1;
stamping out further sheet metal elements with an identical stamped-out geometry as the first sheet metal element, wherein after stamping out a sheet metal element the stamping device that has been used is rotated in each case by an angle that corresponds to 360°/number of the soft-iron cores,
wherein the stamped out sheet metal elements are arranged one above the other and connected to one another; and
arranging the permanent magnets in the intermediate spaces of the sheet metal element packet that is produced.

In some embodiments, the stamped-out sheet metal elements are connected to one another sequentially in each case after being stamped out.

In some embodiments, the stamped out sheet metal elements are provided in each case with two connecting pieces.

In some embodiments, the stamped-out sheet metal elements are provided with connecting pieces that protrude from the opposite-lying soft-iron core sections.

In some embodiments, a rotor is produced and the sheet metal elements of said rotor comprise ten soft-iron core sections.

In some embodiments, the individual sheet metal elements are connected to one another by way of protrusions and depressions.

In some embodiments, the individual sheet metal elements are connected to one another by way of protrusions and depressions on the central ring.

In some embodiments, the sheet metal elements are stamped out, wherein the central ring of said sheet metal elements comprises radially outwards directed bulges and the connecting pieces extend from said bulges.

The present disclosure provides methods that are particularly simple to implement for a rotor form that is particularly favorable as far as the electromotive characteristics are concerned.

### BRIEF DESCRIPTION OF THE DRAWINGS

The invention is explained in detail herein under with reference to an exemplary embodiment in conjunction with the drawing, in which:

FIG. 1 illustrates a plan view of a sheet metal element packet of a rotor for a permanently excited synchronous motor; and

FIG. 2 illustrates a three-dimensional view of the sheet metal element packet illustrated in FIG. 1.

### DETAILED DESCRIPTION

An example method of the type mentioned may include:

Producing the sheet metal element packet by means of:
Stamping out a first sheet metal element in such a manner that the sheet metal element comprises at least one connecting piece and a maximal number of connecting pieces that corresponds to the number of the soft-iron core sections -1;
Stamping out further sheet metal elements with the identical stamped-out geometry as the first sheet metal element, wherein after stamping out a sheet metal element the stamping device that has been used is rotated by an angle that corresponds to 360°/number of the soft-iron cores,
   wherein the stamped out sheet metal elements are arranged one above the other and connected to one another; and
Arranging the permanent magnets in the intermediate spaces of the sheet metal element packet that is produced.

When using the method, the number of connecting pieces between the soft-iron core sections and the central ring are reduced, without having a considerable adverse effect on the electromotive characteristics of the motor and without adversely affecting the handling procedure or reducing the stabilization of the sheet metal packet. Thin sheet metal elements may be used for producing the sheet metal packet, said sheet metal elements having an identical cut-out or stamped-out geometry. The method may include producing at the relevant stamping device no sheet metal elements that have mutually different geometries but rather to produce sheet metal elements that have identical stamped-out geometries. Sheet metal elements that comprise a reduced number of connecting pieces are stamped out. Thus, a maximum number of connecting pieces are used, said number being the number of the soft-iron core sections −1 or the number of the magnetic poles −1. Therefore, in the case of one sheet metal element, not each soft-iron core section is connected to the central ring but rather maximal a number of soft-iron core sections that is reduced by 1.

In some embodiments, the stamped-out sheet metal elements are provided only with two connecting pieces in each case, wherein in particular two opposite lying soft-iron core sections are provided with corresponding connecting pieces. In the case of the embodiments of this type, by way of example eight, ten or twelve soft-iron core sections are used, of which, as mentioned, only two are connected to the central ring by way of connecting pieces, as a consequence, a considerable improvement of the electromotive characteristics is achieved since the number of connecting pieces is considerably reduced.

In some embodiments, all the sheet metal elements are produced with an identical stamped-out geometry. After stamping out a sheet metal element, the stamping device being used is rotated in each case by an angle that corresponds to 360°/number of the soft-iron cores. This procedure renders it possible to maintain an identical stamped-out geometry in the case of each sheet metal element yet to achieve that the connecting pieces of the different planes (sheet metal elements) are arranged offset with respect to one another or in steps.

In some embodiments, the stamped-out sheet metal elements are arranged one above the other and connected to one another, wherein the sheet metal elements may be connected sequentially to one another after being stamped out. Therefore, a first sheet metal element is stamped out. Subsequently, a second sheet metal element is stamped out and connected to the first sheet metal element. A third stamped-out sheet metal element is then connected to the unit comprising the first and second sheet metal element, until finally one sheet metal element packet is produced from sheet metal elements that are arranged one another above the other and a single unit is formed.

In the case of this single-unit sheet metal packet, the permanent magnets are then provided in the intermediate spaces between the soft-iron core sections that are arranged one above the other the other.

In some embodiments, a rotor is produced and the sheet metal elements of said rotor comprise in each case ten soft-iron core sections. These sheet metal elements are connected to one another, so that a sheet metal element packet is produced that comprises a total of ten sheet metal elements that are arranged one above the other. In each case, two opposite-lying sheet metal elements comprise a connecting piece to the central ring. Therefore, overall, each fifth section of the soft-iron core sections that are arranged one above the other comprises a connecting piece to the central ring, and each packet of the soft-iron core sections that are arranged one above the other comprises two connecting pieces to the central ring.

As far as the connection of the individual sheet metal elements is concerned, these may be connected by way of protrusions and depressions that are arranged on the individual sheet metal elements and cooperate with one another. Therefore, a further stamped-out sheet metal element is connected in each case to the preceding sheet metal element by way of pimple-type protrusions that engage in corresponding depressions of the other elements so that a connected unit of individual sheet metal elements is always formed. The corresponding protrusions and depressions may be arranged at the respective soft-iron core section. Corresponding structures can however also be arranged on the central ring. Combinations are likewise possible.

In some embodiments, sheet metal elements are stamped out, wherein the central ring of said sheet metal elements comprises bulges that face outwards in a radial direction and the connecting pieces extend from said bulges.

The soft-iron core sections may be embodied in an almost trapezoidal form, wherein the connecting pieces may be connected in the center to the radial inner faces of the soft-iron core sections.

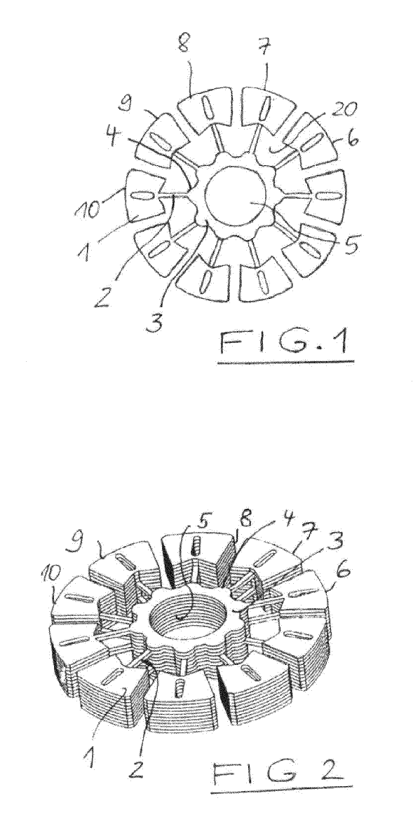

In some embodiments, a rotor for a permanently excited synchronous motor is produced, said rotor comprising ten permanent magnets (not illustrated in the figures) that are arranged in a spoke-shaped pattern of a magazine and are arranged at the sites indicated by the numeral 20 in FIG. 1. The intermediate spaces between the individual permanent magnets are filled with a packet of individual sheet metal elements arranged one above the other and are identified in FIG. 2 by the numerals 6, 7, 8, 9 and 10.

In the case of the embodiment illustrated in the figure, the rotor 10 comprises permanent magnets, and the corresponding packet of individual sheet metal elements that are arranged one above the other comprises ten sheet metal elements 6, 7, 8, 9 and 10 that are arranged one above the other and connected to one another and comprise in each case a radial outer soft-iron core section 1 and a central ring 3 that are connected to one another by way of corresponding thin connecting pieces 2.

FIG. 1 illustrates a plan view of the sheet metal element packet that is embodied from individual thin sheet metal elements 6, 7, 8, 9, 10 and FIG. 2 illustrates a spatial view, wherein the individual thin sheet metal elements arranged one above the other are clearly visible. The sheet metal elements are connected to one another by way of pimple-type protrusions and corresponding depressions (not illustrated in the figures) so that a uniform sheet metal element packet is formed.

In some embodiments, the method arranges as few as possible connecting pieces between the soft-iron core sections 1 and the central ring 3, yet thereby not to impair the electromotive characteristics of the rotor and/or not adversely affect the handling and stabilization of the single unit. In order to achieve this, not every soft-iron core section 1 of a sheet metal element is connected to the central ring 3 but rather fewer connecting pieces 2 are provided as soft-iron core sections 1.

In the case of the illustrated embodiment, only two opposite-lying soft-iron core sections 1 of each sheet metal element are provided with connecting pieces 2, whereas the remaining soft-iron core sections of this sheet metal element do not have any connecting sections. As is evident in FIG. 2, two opposite-lying soft-iron core sections of the uppermost sheet metal element 6 are hereby each provided with a connecting piece 2. Also in the case of the sheet metal element 7 lying below this, only two connecting pieces are provided. The same applies for the further sheet metal elements 8, 9, 10 etc.

Each sheet metal element may comprise an identical cut-out or stamped-out geometry, in other words each sheet metal element is embodied in an identical manner. During the stamping-out procedure, the stamping device is rotated by an angle of 360/10=36° so that the connecting pieces of the next stamped-out sheet metal element are arranged offset in each case by 36° with respect to the preceding sheet metal element. This therefore results in the stepped arrangement of the connecting pieces as illustrated in FIG. 2.

As is evident in FIG. 2, ten sheet metal elements are hereby arranged one above the other. The uppermost five sheet metal elements 6, 7, 8, 9 and 10 comprise connecting pieces 2 that are arranged in a stepped manner as described. A further five sheet metal elements that comprise accordingly stepped connecting pieces are arranged below said sheet metal element.

During the procedure of producing the individual sheet metal elements, the lowermost sheet metal element illustrated in FIG. 2 is stamped out by way of example as the first sheet metal element. The stamping device is then rotated by 36° so that the next sheet metal element is stamped out in an identical manner yet only with two connecting pieces that are arranged offset by 36°. Two sheet metal elements are then connected to one another by way of the mentioned pimple-like protrusions and depressions, following which the third sheet metal element is stamped out in a corresponding manner in turn with connecting pieces that are arranged offset by 36° and is connected to the preceding elements.

This procedure is continued until all ten sheet metal elements are stamped out, connected and in position. Subsequently, the sheet metal packet unit is produced that is illustrated in FIG. 2 and can be provided with the permanent magnets. Finally, the rotor that has been produced can be connected to a shaft that extends through the cut-out indicated by the numeral 5.

The central ring comprises rounded bulges 4 that in the case of this embodiment face outwards in a radial manner and the connecting pieces 2 of said bulges extend outwards in a radial manner.

What is claimed is:

1. A method for producing a rotor for a permanently excited synchronous motor, the method comprising:
arranging a plurality of permanent magnets in a spoke-shaped pattern;
disposing a number of sheet metal elements between the respective permanent magnets;
the respective sheet metal elements arranged one above the other and connected to one another;
the respective sheet metal elements comprising sections of soft-iron cores, a ring in the center of the rotor, and thin connecting pieces that connect the soft-iron core sections to the ring;
producing the number of sheet metal elements in a packet by:
stamping out a first sheet metal element in such a manner that the sheet metal element comprises at least one connecting piece and a maximal number of connecting pieces that corresponds to one less than the number of the soft-iron core sections;
stamping out further sheet metal elements with an identical stamped-out geometry as the first sheet metal element, wherein after stamping out a sheet metal element the stamping device is rotated in each case by an angle that corresponds to 360° divided by the number of the soft-iron cores.

2. The method as claimed in claim 1, further comprising connecting the respective stamped-out sheet metal elements to one another sequentially in each case after being stamped each one out.

3. The method as claimed in claim 1, further comprising stamping out two connecting pieces for each of plurality of stamped out sheet metal elements.

4. The method as claimed in claim 1, further comprising stamping out connecting pieces protruding from the opposite-lying soft-iron core section for each of the plurality of stamped-out sheet metal elements.

5. The method as claimed in claim 1, wherein the rotor comprises ten soft-iron core sections.

6. The method as claimed in claim 1, further comprising connecting the individual sheet metal elements to one another by way of protrusions and depressions.

7. The method as claimed in claim 1, further comprising connecting the individual sheet metal elements to one another by way of protrusions and depressions on the central ring.

8. The method as claimed in claim 1, wherein the central ring of said sheet metal elements comprises radially outwards directed bulges and the connecting pieces extend from said bulges.
